(19) United States
(12) Patent Application Publication
(10) Pub. No.: US 2011/0276549 A1
(43) Pub. Date: Nov. 10, 2011

(54) OPTIMISTIC LOCKING IN A DISTRIBUTED FILE SYSTEM REPLICATION ENVIRONMENT

(75) Inventor: Diaa E. Fathalla, Redmond, WA (US)

(73) Assignee: Microsoft Corporation, Redmond, WA (US)

(21) Appl. No.: 12/773,113

(22) Filed: May 4, 2010

(51) Int. Cl. G06F 17/30

(52) U.S. Cl. 707/704; 707/E17.007

(57) ABSTRACT

Described is optimistic locking in a distributed file system replication environment, in which a replica machine (e.g., a replicated file server) sends an optimistic lock to other replica machines when a file is opened for write access. Other replica machines that receive the optimistic lock prevent read-write opening of the file until the file is unlocked, thereby preventing many conflicts. Acknowledgements are not required by the locking replica. Of the reduced number of conflicts, many of those conflicts may be detected and thus handled before the file is closed, while conflicts detected after close may be handled via conventional conflict resolution techniques, e.g., last-writer wins.

### BACKGROUND

In a distributed file system replication environment, various users can modify data on multiple servers. Because of this, is possible for users to overwrite each other's changes, which causes conflict problems.

To prevent such overwriting/conflict problems, the use of brokering mechanisms and distributed locking solutions have been tried. However, brokering mechanisms need to have a fully routed network and do not use multi-master replication. Distributed locking mechanisms are very complex, and thus have a number of drawbacks.

As a result, contemporary distributed file system replication systems use a more straightforward solution, namely a “last writer wins” conflict algorithm, in which the last user to save (close) a commonly edited file has the changes kept. The losing file copy is maintained in a “ConflictAndDeleted” folder. This is not a desirable solution in many scenarios.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a replica machine of a plurality of networked replica machines can optimistically lock a file to prevent many overwriting conflicts. A replica machine determines whether a file to be opened for editing/writing is optimistically locked by another replica machine. If not, the file is opened for read-write access, and a distributed locking update is sent to other replica machines to optimistically lock the file on each other replica machine. A kernel mode locking filter driver may detect the open request, and a user mode service may distribute the lock. An acknowledgement need not be received from each other replica to allow editing. The lock may be periodically or otherwise persisted by sending other lock updates during editing.

If the file is locked by another replica, the file may be opened for read-only access. A locked file may be forced to be unlocked, if not unlocked or persisted within a time that is generally larger than a persist time.

Conflicts are possible with optimistic locks, including a conflict that is detected by receiving another lock update from another machine for this file while the file is open for writing. If so, at least one early conflict resolution action may be performed, e.g., notifying the user before the file is closed. If a conflict is detected after the file is closed, another conflict resolution action may be taken, such as the conventional “last-writer-wins” action.

When editing completes, the file is closed and an unlock update sent. The unlock update may be delayed for a time to ensure that the file is not quickly reopened, which may occur with some programs that close and automatically reopen a file upon a save operation rather than an actual user-intended file close operation.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example distributed file system replication environment that implements optimistic locks.

FIG. 2 is a flow diagram representing example concepts related to optimistic locks with respect to opening a file for editing.

FIG. 3 is a flow diagram representing example concepts related to handling receipt of an optimistic lock/forcing an unlock of an optimistically locked file.

FIG. 4 shows an illustrative example of a computing environment into which various aspects of the present invention may be incorporated.

### DETAILED DESCRIPTION

Various aspects of the technology described herein are generally directed towards an optimistic locking solution in which a file open (or first write) operation results in a distributed lock update (notification) that attempts to exclusively lock the file. If the lock update is received at other replica machines before any other user opens the file, then the lock prevents others from opening the file for writes (read-only opens may be allowed).

While this generally succeeds a relatively high percentage of the time, the lock update is only optimistic, in that having the lock is not a guarantee that there is no current or future conflict; there is no requirement than an acknowledgement be received, (although such an implementation is feasible). For example, if the lock update is not received in time by another machine to prevent another open on that other machine, then there is a conflict. However, the conflict may be detected while the file is still open, rather than after file close. This allows early conflict detection resolution actions to be taken, such as notifying the user and giving the user an opportunity to save a file copy to a different filename. As another example, if the lock update is not received at all, such as because a network is disconnected (not all nodes are presently able to communicate with one another), then a conflict resolution algorithm such as last-writer-wins may be used. In this way, for a relatively high percentage of file opens, the lock prevents conflicts; the relatively low percentage of conflicts can be handled upon detection, including early detection or via a last-writer wins solution as used today.

It should be understood that any of the examples herein are non-limiting. Indeed, the use of a filter driver as described herein to detect file opens and closes is only one mechanism to implement optimistic locking, and the metadata described herein is only an example for a suitable file system. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and file replication in general.

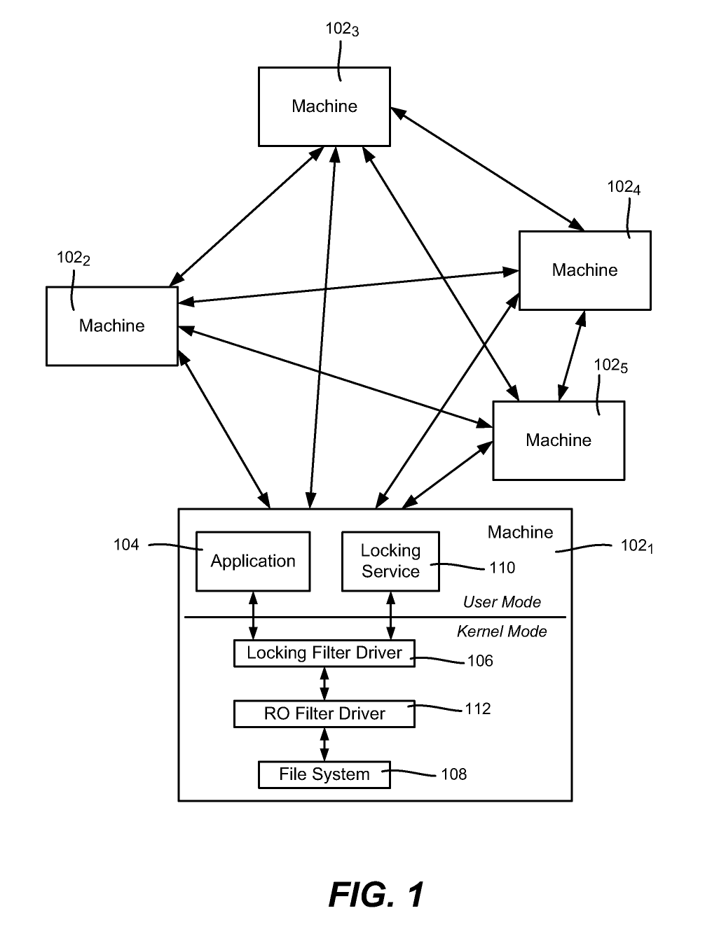

FIG. 1 shows a general example network for optimistic locking implemented among a plurality of replica machines 102₁-102₅, such as file servers. While five such machines 102₁-102₅, are shown in FIG. 1 as an example, it is understood that a network may have any practical number.

For convenience, FIG. 1 shows certain internal components of only one of the machines, namely the machine 102₁, however it is understood that the other machines 102₂-102₅ include like components. As represented in the machine 102₁, when a file is opened for write, such as by any suitable application program 104, a locking filter driver 106 detects the open for write request headed for the file system 108. Note that alternatively, the detection may be on the first write. Upon detection, a lock update is created, such as a field in the IDRecord for the file.

The lock update then gets propagated to the other machines, such as via a user mode locking service 110. On the other participating machine replicas, the file typically becomes read only via appropriately set attributes, and an identifier of the locking replica machine (e.g., a GUID of the locking replica's database) is maintained in association with the file, e.g., in an alternate data stream DB_GUID:$DATA of the file. Each replicated folder that sees the lock update prevents a read-write open, e.g., by adding the file to a read-only (RO) filter driver (each other machine's counterpart to the filter driver 112 of the machine 102₁), whereby the file only may be opened as read-only on that machine. Other mechanisms are feasible, e.g., a per-file rather than per-folder filter driver may lock the file for read-only open, file access may be denied entirely rather than allowing read-only access, and so forth.

Note that conflicts that may occur are considered, such as when one machine receives a distributed lock update for a file that is already locked on that machine, which may result from slow network conditions in conjunction with simultaneous or near-simultaneous opening on two or more replicas. In that situation, early conflict resolution actions may be taken, such as to notify the users of the conflict and have them save their file copy to a different name, or abandon their changes.

As another example of a conflict, consider two subnets where the connection between the subnets becomes disconnected, such that a file becomes open in both subnets. In this situation, the file is locked for the individual lock requestors in each subnet. When the connection is restored, a conflict resolution algorithm resolves the conflict, such as the conventional “last writer wins” conflict resolution algorithm. As can be seen, the technology thus provides “best efforts” locking that significantly reduces the timing window for possible conflicts, yet handles the remaining conflicts that do occur.

The opened file is unlocked in a similar manner following the close of the file, that is, via an unlock update. However, the unlock update may not be sent or received, e.g., if the locking machine or communication with the locking machine has failed. To this end, a machine holding a lock persists that lock while the file is still open via lock updates. If an unlock update is not received in a timely manner, and the machine that has locked a file has not timely persisted the lock, a forced unlock mechanism unlocks the file. In this way, after an administrator-configurable timeout value, individual files are released based on their lapsed timeout if no updates are received within the timeout window. When the service restarts, the timeout is reset, but can be persisted per each file as desired.

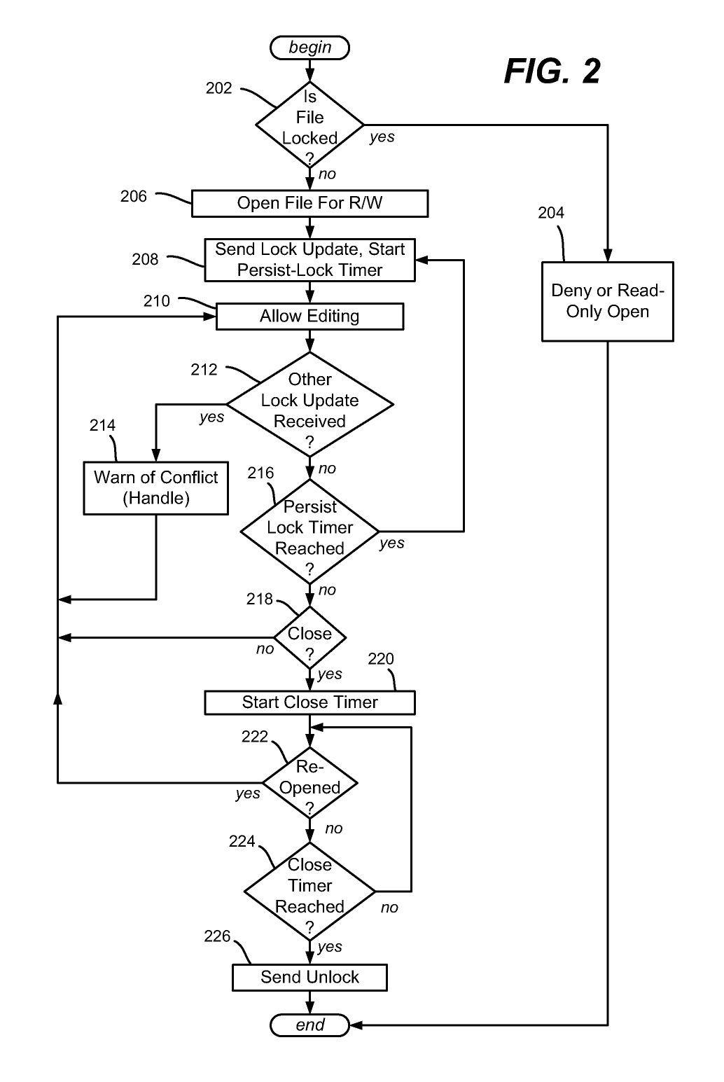

FIG. 2 shows example concepts in the form of a flow diagram of example steps. Note that FIG. 2 is not necessarily intended to show actual logic, but rather various aspects; for example, separate event timers and the like may be used rather than steps within a loop. The steps begin upon receiving a file open request intended for read and write, (R/W).

Step 202 evaluates whether the file is already locked. If so, step 204 is executed, which denies access or allows read-only access, e.g., depending on administrator configuration. If not locked, step 206 opens the file with read-write access (or simply, “opens for writing”), and starts a persist lock timer, as described below.

Once open for read-write, editing is allowed as represented by step 210. While editing, a number of actions may occur. For example, as represented by step 212, a lock update from another machine may be received. For example, due to transmission delays, two machines may not receive each other's lock update in time before each allows its respective copy of the file to be opened for read/write. If so, early conflict detection occurs as represented via step 212, whereby step 214 allows for some action to be taken, e.g., the user can be warned of the conflict, which can be avoided by saving to a different filename, or via external means (e.g., contacting the other party if known).

As described herein, a file unlock may need to be forced to prevent a file from being left in a locked state, such as due to machine or network failure. In a normal situation, however, until unlocked via closing the file, the lock is persisted on occasion, such as periodically. This persist time may be configurable so as to not flood the network with lock updates, but in general, is less than the forced-unlock time. For example, one administrator may specify that the lock be persisted every thirty seconds, with a forced update occurring if no lock update is received after two persist periods, e.g., just over one minute. Another administrator may specify persisting/forcing on the order of several minutes, or even hours, essentially trading off the number of updates sent over the network versus file write availability.

Step 216 represents checking whether the persist timer (which was started at step 208) has been reached. If so, step 216 branches back to step 208 where another lock update is sent, and the persist timer restarted.

Step 218 represents detecting a close operation, e.g., as notified by the locking filter driver via an appropriate event. If not closed, editing continues (step 210).

If closed, then a file unlock may need to be sent (step 226). However, before doing so, some time is allowed to transpire (via steps 220 and 224) because the detected “close” at step 218 may not be an actual user-intended close. More particularly, some programs perform a close operation on a file handle when the file is saved, but open a copy of the file with the same name via another handle, essentially using two file handles per file. The close/reopen operation on such a save operation is relatively fast, and is transparent to the user. Thus, rather than flood the network with an unlock update followed soon thereafter with another lock update, some time is allowed (such as on the order of seconds) to see if the file was closed and reopened (step 222) relatively quickly. Note that if a user does happen to close and re-open a file within this allowed time period, the user simply gets the benefit of having the file remain locked, which is what the user likely desires to have happen.

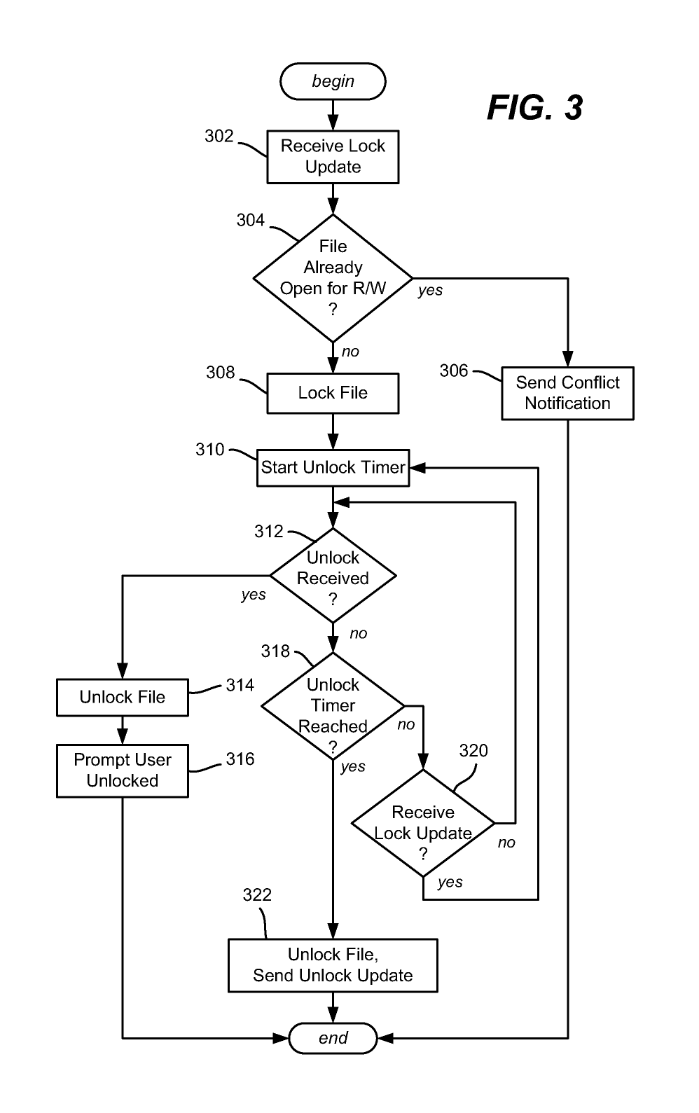

FIG. 3 shows some example concepts regarding handling receipt of a lock update (step 302). FIG. 3 (like FIG. 2) is in the form of a flow diagram of example steps, but is not necessarily intended to show actual logic. Note that some of FIG. 3 may be performed by the locking service 110, but instead may be performed by one or more agents on the network that unlock files whose locks are not persisted within the allowed persist time.

Step 304 evaluates whether the file is already open for read-write at another machine, in which event early conflict detection and resolution may apply (step 306) as described above. If not, step 308 locks the file, and step 310 starts an unlock timer, which will force an unlock if reached before the lock is persisted (as described above) if the file has not otherwise been unlocked (step 312).

If properly unlocked by the replica that locked the file, step 312 branches to step 314 to unlock the file at this replica (e.g., adjust the attributes/inform the read-only filter driver). If desired and applicable, the user may be notified of the unlock (step 316), e.g., a user who has the file open as read-only may be notified that the user may now open the file for read-write.

Step 318 evaluates the unlock timer. If not yet reached, step 320 evaluates whether the file lock was persisted; if so, step 320 branches back to step 310 to restart the unlock timer. If not, step 318 branches to step 322 where a forced unlock is performed on the machine that evaluates the lock versus unlock timing; this forced unlock may be distributed to other replica machines.

In this manner, the opportunity for a conflict is significantly reduced. At the same time, in many situations the technology provides for early conflict detection in the event of a conflict. Only if there is a later-detected conflict may the “last-writer-wins” or other conflict resolution apply, which is no worse than what current technology provides.

### Exemplary Operating Environment

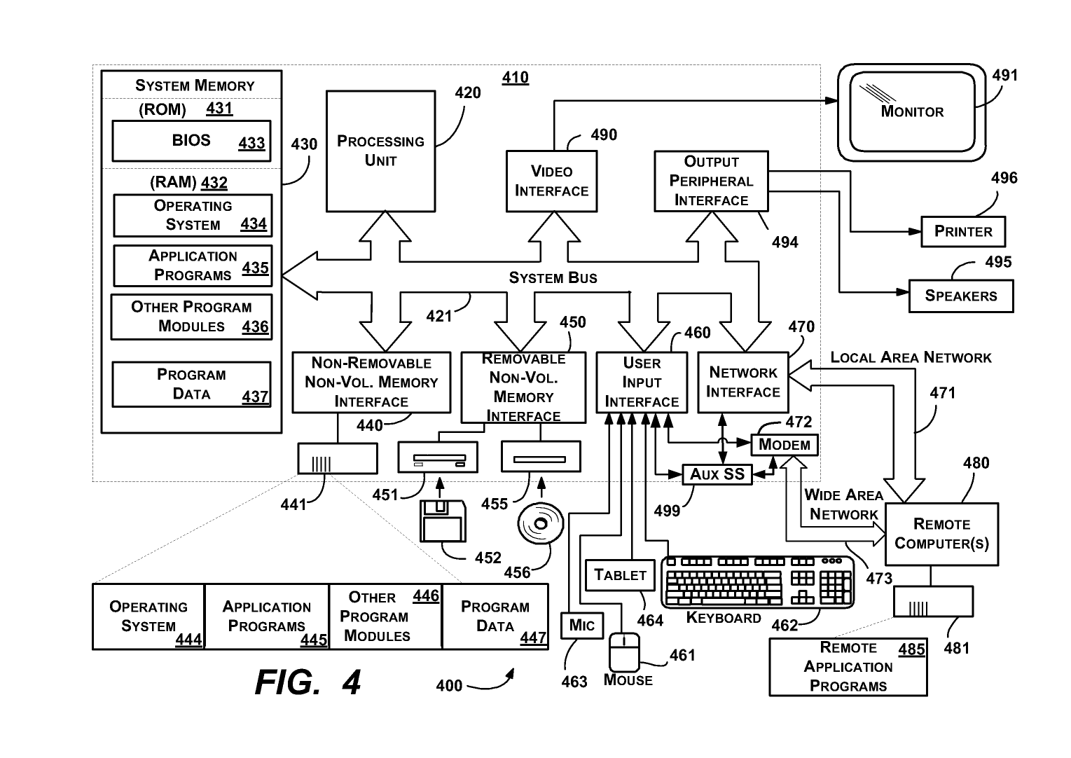

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor comprising, in a replica machine of a plurality of networked replica machines, determining whether a file for which a read-write open has been requested is optimistically locked by another replica machine, and if not, opening the file for read-write, and sending a distributed locking update to one or more other replica machines to optimistically lock the file on each other replica machine.

2. The method of claim 1 wherein opening the file for writing includes not waiting for any acknowledgement from any other replica indicating that the file is optimistically locked.

3. The method of claim 1 further comprising, persisting the optimistic lock by sending at least one other lock update at a persist time.

4. The method of claim 1 further comprising, receiving another locking update from another machine for the file while file is open for writing, and performing at least one early conflict resolution action.

5. The method of claim 4 wherein performing at least one early conflict resolution action comprises notifying a user who has the file open for writing.

6. The method of claim 1 further comprising, detecting a conflict after the file is closed, and performing a conflict resolution action.

7. The method of claim 1 further comprising, detecting a conflict after the file is closed, and performing a last-writer-wins conflict resolution action.

8. The method of claim 1 further comprising, closing the file and sending an unlock update.

9. The method of claim 1 further comprising, closing the file, waiting for a reopen time, and sending an unlock update if the file is not reopened during the reopen time.

10. The method of claim 1 further comprising, determining that the file is optimistically locked by another replica, and opening the file as read only.

11. The method of claim 10 further comprising, determining whether the optimistically locked file has not been persisted within a forced unlock time, and if so, unlocking the file.

12. In a computing environment, a system comprising, a plurality of replica machines, each replica machine having a mechanism that optimistically locks a file upon a file open or first file write request when that file is not already optimistically locked, including by communicating to send an optimistic lock to any other communicating replica machine, each replica machine preventing read-write opening of the file when the file is already optimistically locked by another replica machine.

13. The system of claim 12 wherein the mechanism comprises a kernel mode locking filter driver that detects a file open request, and wherein the locking filter driver communicates with a user mode service that sends the optimistic lock.

14. The system of claim 12, wherein each replica machine prevents read-write opening of the file when the file is already optimistically locked by blocking opening for write access at a kernel mode read-only filter driver.

15. The system of claim 12 wherein one replica machine has optimistically locked the file, and wherein that replica machine persists the optimistic lock.

16. The system of claim 12 wherein one replica machine has optimistically locked the file, and wherein that replica machine closes the file, waits for a reopen time, and sends an unlock update if the file is not reopened during the reopen time.

17. The system of claim 12 further comprising an unlock mechanism that forces an unlock of the file if not unlocked or persisted within a forced unlock time.

18. The system of claim 12 wherein the file is optimistically locked by metadata associated with the file.

19. One or more computer-readable media having computer-executable instructions, which when executed perform steps, comprising:
receiving a read-write open request for a file at a replica machine of a plurality of networked replica machines;
determining whether the file is optimistically locked by another replica machine, and if so:
(i) preventing opening of the file or allowing the file to be opened for read only access,
and if not:
(ii) opening the file for read-write access, sending a distributed locking update to one or more other replica machines to optimistically lock the file on each other replica machine, persisting the optimistic lock when a persist time is reached by sending at least one other lock update, and sending an unlock update based upon closing the file.

20. The one or more computer-readable media of claim 19 having further computer-executable instructions comprising, determining that the file is optimistically locked by another replica, and unlocking the file if the file has not been unlocked or persisted within a forced unlock time.
